(19) United States
(12) Patent Application Publication
(10) Pub. No.: US 2013/0218671 A1
(43) Pub. Date: Aug. 22, 2013

(54) SYSTEM AND METHOD FOR SELECTION AND DELIVERY OF A TARGETED ADVERTISEMENT TO A SHOPPING CART

(71) Applicant: FORMCEPT Technologies and Solutions Pvt. Ltd., (US)

(72) Inventors: AKRAM KHAN, BANGALORE (IN); ANUJ KUMAR, BANGALORE (IN); KULDEEP BORA, BANGALORE (IN); SURESH SRINIVASAN, BANGALORE (IN)

(73) Assignee: FORMCEPT Technologies and Solutions Pvt. Ltd., Bangalore (IN)

(21) Appl. No.: 13/769,285

(22) Filed: Feb. 16, 2013

(30) Foreign Application Priority Data
Feb. 17, 2012 (IN) 586/CHE/2012

(51) Int. Cl. G06Q 30/02

(52) U.S. Cl. CPC G06Q 30/0251
USPC 705/14.49

(57) ABSTRACT

A method of selecting and displaying of a targeted advertisement at a shopping cart is provided. The method includes (a) processing, by a processor, a product identifier received; from the shopping cart when a first product added to the shopping cart (b) obtaining one or more price indicators that correspond to the first product in the shopping cart, (c) selecting one or more advertisements that correspond to the first product based on (i) the product identifier, and fit) the one or more price indicators, and (d) delivering or displaying the one or more advertisements at the shopping cart. The product identifier is unique and specific to the first product.

### CROSS-REFERENCE TO RELATED APPLICATION

This application claims priority to Indian patent application no. 586/CHE/2012 filed on Feb. 17, 2012, the complete disclosure of which, in its entirely, is herein incorporated by reference.

### TECHNICAL FIELD

The embodiments herein generally relate to distribution of multimedia content, and more particularly to a system and method, for selection and delivery of a targeted advertisement to a shopping cart based on a product added to the shopping cart, and/or price indicators from one or more advertisers.

### DESCRIPTION OF THE RELATED ART

Promotions and advertisements targeting potential buyers inside shopping malls, and retail chains premises may have a substantial influence on their buying decisions. Typically, paper pamphlets, signage or posters may be distributed to visitors inside a shopping mall or a retail outlet. However, these advertisements do not take into account a specific customer's current baying behavior, preferences or buying patterns, Advertisers may spend substantially on advertisements on television or newspapers, but they may not directly influence a purchasing decision at a retail outlet, due to their limited recall value. Accordingly, there remains a need for selecting and delivering targeted advertisements to buyers that are likely to influence their purchasing decisions at retail outlets. Further, there is a need for advertisers to optimize their advertising spend to target people who are more likely to purchase the products being advertised, at the right time.

### SUMMARY

In view of the foregoing, art embodiment herein provides a method of selecting and displaying of a targeted advertisement at a shopping cart. The method includes processing, by a processor, a product identifier received from the shopping cart when a first product added to the shopping cart. The product identifier is unique and specific to the first product. The method includes obtaining one or more price indicators that correspond to the first product in the shopping cart. The method includes selecting one or more advertisements that corresponds to the first product based on (i) the product identifier, and (ii) the one or more price indicators. The method includes delivering or displaying the one or more advertisements at the shopping cart.

The one or more advertisements may be further selected based on (i) a preset of rules that are defined before adding the first product in the shopping cart. The one or more price indicators may be stored in a database. The one or more price indicators may be obtained when the first product is added to the shopping cart. The one or more advertisements may include one or more (i) an offer, and (ii) a discount on purchasing the first product The one or mote advertisements may include a promotion on a second product on purchasing the first product. The second product may be different from the first, product The product Identifier may include one or more (i) a code, (ii) a hatch number, and (iii) a name of a manufacturer associated with the first product.

The one or more advertisements may include a promotion on a second product on purchasing the first product. The second product may be different from the first product. The product identifier may include one or more (i) a code, (ii) a hatch number, and (iii) a name of a manufacturer associated with the first product. The one or more advertisements delivered to the shopping cart may include one or more (i) an audio message, (ii) a visual message, and (iii) a printable message. The one or more price indicators may be obtained based on a previous transaction associated with previous purchase of the first product

In another embodiment, an intent channel server for selection and displaying of a targeted advertisement at a shopping cart is provided. The intent channel server .includes a memory unit that stores (i) a set of modules, and (ii) a database comprising (a) one or more price indicators, (b) one or more advertisements, and (c) one or snore product identifiers, and (d) a preset of roles that axe defined before adding a product in the shopping cart. The intent channel server further includes a display unit. The intent channel server further includes a processor that executes the set of modules. The set of modules include a product identifier processing module executed by the processor that processes a product identifier received from the shopping cart when a first product added to the shopping cart. The product identifier is unique and specific to the shopping cart. The set of modules include an advertisement selection module executed by the processor that selects one or more advertisements that corresponds to the first product from the one or more advertisements based on (i) the product identifier, (ii) the one or more price indicators, and (iii) the preset of rules that are stored in the database before adding the first product in the shopping cart. The set of modules include an advertisement delivering module executed by the processor that delivers the one or more advertisements to the shopping cart. The one or more advertisements may further include erne or more (i) an offer, and (ii) a discount on purchasing the first product. The one or more advertisements further include a promotion on a second product on purchasing the first product. The second product may be different from the first product.

In yet another embodiment, a system for selection and displaying of a targeted advertisement at a shopping cart is provided. The system includes a transceiver associated with the shopping cart. The transceiver includes (i) a processor that is configured to (a) identify a product identifier which is unique and specific to a first product when the first product added to the shopping cart, (b) obtain one or more price indicators when the first product is added in the shopping cart, (c) select one or more advertisements that correspond to the first product based on (i) the product identifier, and (ii) the one or more price indicators, and (d) display the one or more advertisements in the shopping cart. The one or more price indicators correspond to the first product. The one or more advertisements may include at least one of (i) an offer, and (ii) a discount on purchasing the first product. The one or more advertisements may include a promotion on a second product on purchasing the first product. The second product may be different front the first product. The processor may be further configured to (e) obtain the one or more price indicators based on a previous transaction associated with previous purchase of the first product.

In a further embodiment, an intent channel server for selection and displaying of a targeted advertisement at a shopping cart is provided. The intent channel server includes (a) a memory unit that stores (i) a set of modules, and (ii) database, (b) a display unit, and (c) a processor that executes the set of modules. The set of modules includes (a) a product identifier processing module executed by the processor that processes a product identifier received from the shopping cart when a first product added to the shopping cart. The product identifier is unique and specific to the shopping cart. The set of modules further include (b) a price indicator obtaining module executed by the processor that obtain one or more price indicators when the first product is added in the shopping cart, (c) an advertisement selection module executed by the processor that selects one or more advertisements that correspond to the first product based on (i) the product identifier, and (ii) the one or more price indicators, and (c) an advertisement delivering module executed by the processor that delivers the one or more advertisements to the shopping cart. The one or more indicators correspond to the first product.

In a further embodiment, a system, for selection and displaying of a targeted advertisement at a shopping cart is provided. The system includes a transceiver associated with the shopping cart. The transceiver includes a processor that is configured to (a) process a product identifier when a first product added to the shopping cart, (b) select one or more advertisements that correspond to the first product based on (i) the product identifier, and (ii) one or more price indicators, and (iii) a preset of rules, and (c) display the one or more advertisements in the shopping cart. The product identifier is unique and specific to the shopping cart. The preset of rules and the one or more price indicators are defined before adding the first product in the shopping cart.

In a further embodiment, a method of selecting and displaying of a targeted advertisement at one or more shopping carts are provided. The method includes (a) processing, by a processor, one or more product identifiers received from the one or more shopping carts when one or more products are added to the one or more shopping carts, (b) identifying the one or more products based on the one or more product identifiers, (c) obtaining one or more price indicators based on the one or more products in the one or more shopping carts, (d) selecting one or more advertisements that correspond to at least one product of the one or more products based on (i) the one or more product identifiers, and (ii) the one or more price indicators, and (e) delivering or displaying the one or more advertisements at the one or more shopping carts. Each product identifier of the one or more product identifiers is unique and specific to a product of the one or more products.

### BRIEF DESCRIPTION OF THE DRAWINGS

The embodiments herein will be better understood from the following detailed description with reference to the drawings, in which:

FIG. 1 illustrates a system view of one or more advertisers and one or more content providers communicating with an intent channel server or a transceiver of a shopping cart to display one or more multimedia content, according to an embodiment herein;

FIG. 2 illustrates an exploded view of the advertisement selection and delivery tool of FIG. 1 according to an embodiment herein;

FIG. 3 is a flow diagram illustrating a method of selecting and displaying a targeted advertisement at the shopping cart based on preset rules according to an embodiment herein;

FIG. 4A is a table view illustrating preset rules and price indicators that are defined to display one or more advertisements before adding a product to the shopping cart by the customer of FIG. 1 according to an embodiment herein;

FIG. 4B is a table view illustrating preset rules and price indicators that are defined to display one or more advertisements before adding a product to an online shopping cart by the user of the E-commerce portal of FIG. 1 according to an embodiment herein;

FIG. 5 is a flow diagram illustrating a method of selecting and displaying one or more advertisements when a product is added to the shopping cart according to an embodiment herein;

FIG. 6A is a table view illustrating price indicators that are defined to display one or more advertisements when a product is added to the shopping cart by the customer of FIG. 1 according to an embodiment herein;

FIG. 6B is a table view illustrating price indicators that are defined to display one or more advertisement when a product is added in an online shopping cart by the user of the E-commerce portal of FIG. 1 according to an embodiment herein;

FIG. 7 is a flow diagram illustrating a method of selecting and displaying a targeted advertisement at the shopping cart according to an embodiment herein:

FIG. 8 illustrates an exploded view of the transceiver of FIG. 1 according to an embodiment herein; and

FIG. 9 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying, drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

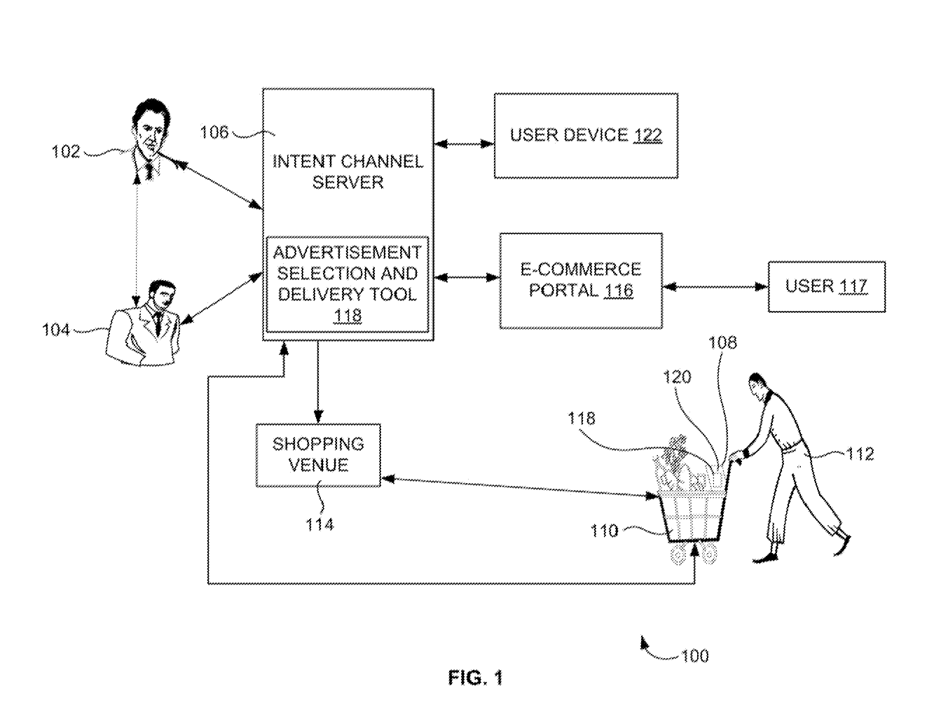

As mentioned, there remains a need for selecting and delivering targeted advertisements to buyers that are likely to influence their purchasing decisions at retail outlets. Further, there is a need for advertisers to optimize their advertising spend to target people who are more likely to purchase the products being advertised, at the sight time. Offers associated with an item that is added to a shopping cart are pushed to the shopping cart. Advertisements (e.g., offers) may be displayed based on (i) one or more price indicators from one or more advertisers, (ii) hems in a shopping cart, and (iii) a previous purchase history of a user. Referring now to the drawings, and more particularly to FIGS. 1 through 9, where similar reference characters denote corresponding features consistently throughout the figures, there are shown preferred embodiments.

FIG. 1 illustrates a system view 100 of one or more advertisers 102 and one or more content providers 104 communicating with an intent channel server 106 or a transceiver 108 of a shopping cart 110 to display one or more multimedia content according to an embodiment herein. The system view 100 further includes a customer 112, a shopping venue 114, an E-commerce portal 116, and a user 117 of the E-commerce portal 116. In one embodiment, the one or more advertisers 102 may be the one or more content, providers 104. In another embodiment, the one or more content providers 104 may be a third party entity such as a retail owner, a shopping mall owner, etc.

The one or more advertisers 102 may directly push their content to the intent channel server 106 without intervention of the one or more content providers 104. The multimedia content may include an advertisement offers (e.g., a seasonal offer, a clearance sale), vouchers, promotion of a product, and discounts on one or more products. The multimedia content may be text, one or more images, one or more videos, one or more short, movies, HTML, audio, animation clips, a visual message, a printable message, and/or interactive contents, etc. The one or more advertisers 102 provide advertisements for the promotion of their products.

The intent channel server 106 or the transceiver 108 includes an advertisement selection and delivery tool 118. Once an item is identified in the shopping cart 110, the advertisement selection and delivery tool 118 selects and delivers one or more advertisements to display at the shopping cart 110 based on price indicators received from the one or more advertisers 102, The one or more advertisers 102 provide the price indicators to display corresponding advertisements on their products. In one embodiment, the one or more advertisements are delivered in real-time at the shopping cart 110 carried by the customer 112 at the shopping venue 114. In another embodiment, the shopping cart 110 is an online shopping cart at which the one or more advertisements are delivered in order to facilitate a shopping experience of the user 117 of the E-commerce portal 116. In one embodiment, the transceiver 108 includes a shopping cart display device 120 that displays the one or more advertisements.

In one embodiment, the transceiver 108 may be connected to the shopping cart 110. In another embodiment, the shopping cart display device 120 is not a part of the transceiver 108 and is located hi the shopping cart 110. In one embodiment, the advertisement selection and delivery tool 118 pushes one or more real-time offers for the products offered for sale to a user device 122, The user device 122 may be a mobile phone, a personal digital assistant (PDA), a pager, and a tablet PC of the customer 112.

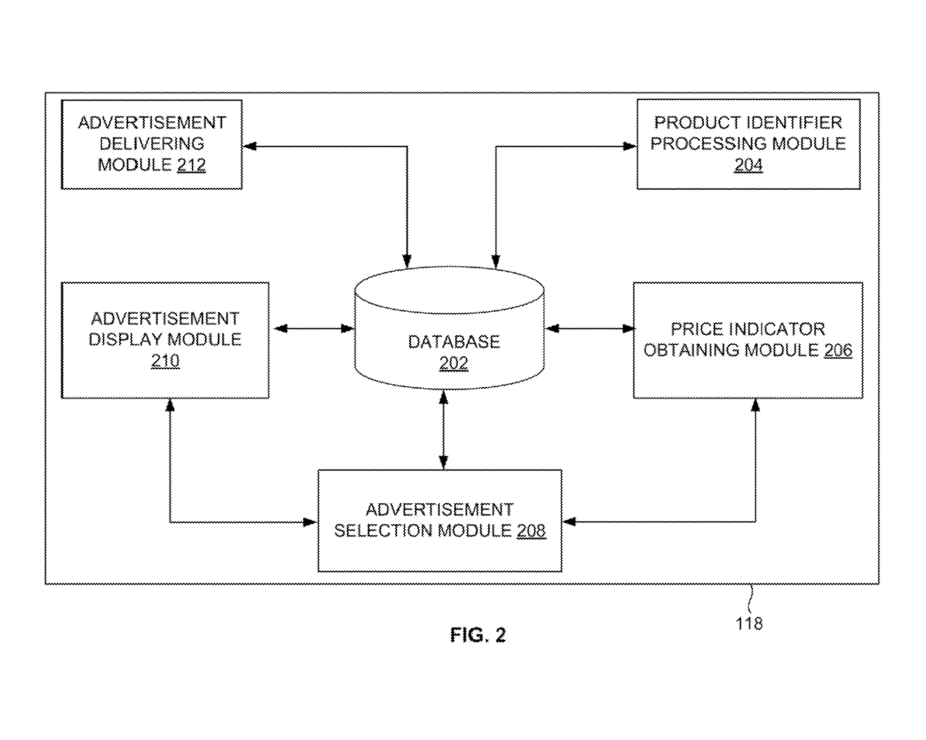

FIG. 2 illustrates an exploded view of the advertisement selection and delivery tool 118 of the intent channel server 106 or the transceiver 108 of FIG. 1 according to an embodiment herein. The advertisement selection and delivery tool 118 includes a database 202, a product identifier processing module 204, a price indicator obtaining module 206, an advertisement selection module 208, an advertisement display module 210, and an advertisement delivering module 212. In one embodiment, the database 202 stores (i) one or more product identifiers, (ii) one or more advertisements, and (iii) information on (a) one or more advertisers, (b) price indicators from the one or more advertisers to display or deliver their corresponding advertisements, (c) a previous purchase information of one or more users, and (d) preset rules that are defined before adding a product to the shopping cart 110 to select and display or deliver the one or more advertisements at the shopping cart 110 of FIG. 1. In another embodiment, (i) the one or more advertisements, and (ii) the information on (a) the one or more advertisers, and (b) the price indicators from the one or more advertisers are obtained in real-time.

The product identifier processing module 204 processes a product identifier received from the shopping cart 110 when a product is added to the shopping cart 110. The product identifier is unique and specific to the product. The product identifier processing module 204 further identifies the product added to the shopping cart 110 by comparing corresponding product identifiers of the product with the one or more product identifiers stored in the database 202. The product identifier may include (i) a code (e.g., barcode, QR code, and document fingerprinting), (ii) a hatch number, and (iii) a name of a manufacturer associated with the product.

In one embodiment, the price indicator obtaining module 206 obtains one or more price indicators from the database 202 when the product is added to the shopping cart 110 by the customer 112 or the user 117 of the E-commerce portal 116. The one or more price indicators are defined even before adding the product into the shopping cart 110, and are used to select and display/deliver one or more advertisements at the shopping cart 110. In another embodiment, the price indicator obtaining module 206 obtains one or more price indicators from the one or more advertisers 102 in real-time when the product is added to the shopping cart 110 by the customer 112 or a user of the E-commerce portal 116.

The advertisement selection module 208 selects one or more advertisements from the database 202 or from the one or more advertisers 102 in real-time. In one embodiment, the one or more advertisements is selected based on (i) the product identifier, and (ii) (a) the one or more price indicators, and (b) preset rules that are defined before adding a product into the shopping cart 110. In another embodiment, the one or more advertisements are selected based on (i) the product identifier, and (ii) the one or more price indicators that are obtained when a product is added to the shopping cart 110. In one embodiment, the advertisement display module 210 displays the one or more advertisements in the shopping cart display device 120. The advertisement delivering module 212 delivers the one or more advertisements front the intent channel server 106 to the shopping cart display device 120. In one embodiment, advertisements are displayed sequentially when more than one advertisement is to be displayed.

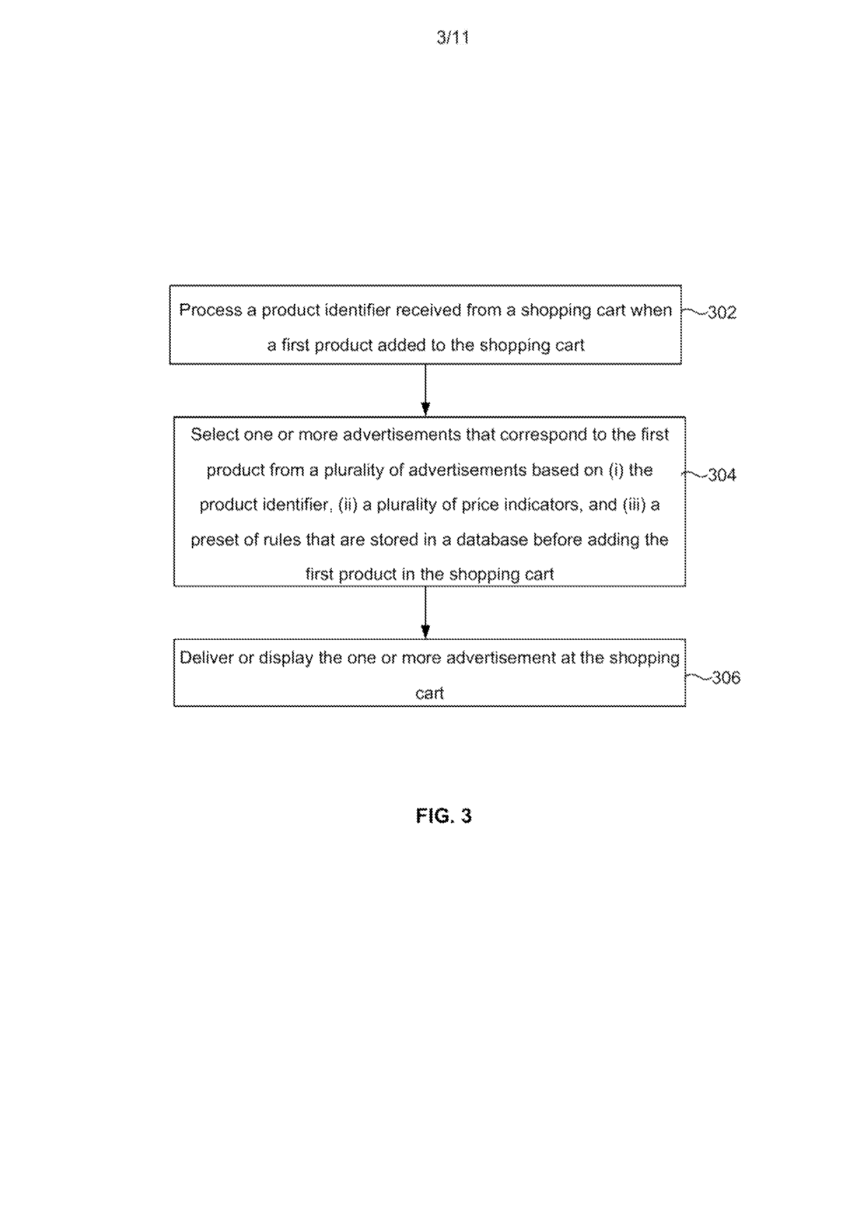

FIG. 3 is a flow diagram illustrating a method of selecting and displaying a targeted advertisement at the shopping cart 110 based on the preset rules according to an embodiment herein. In step 302, a product identifier received from a shopping cart, is processed when a first product added to the shopping cart, in step 304, one or more advertisements that correspond to the first product is selected from, a plurality of advertisements based on (i) the product identifier, (ii) a plurality of price indicators, and (iii) a preset of rules that are stored in a database before adding the first product in the shopping cart. In step 306, the one or more advertisements are delivered and/or displayed at the shopping cart.

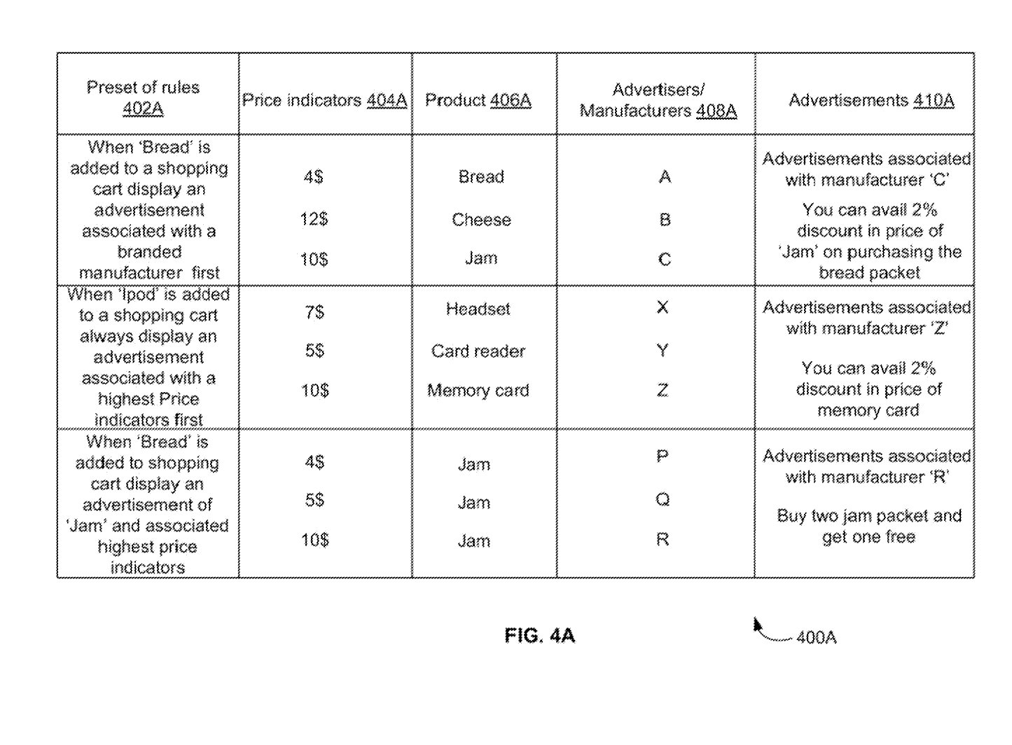

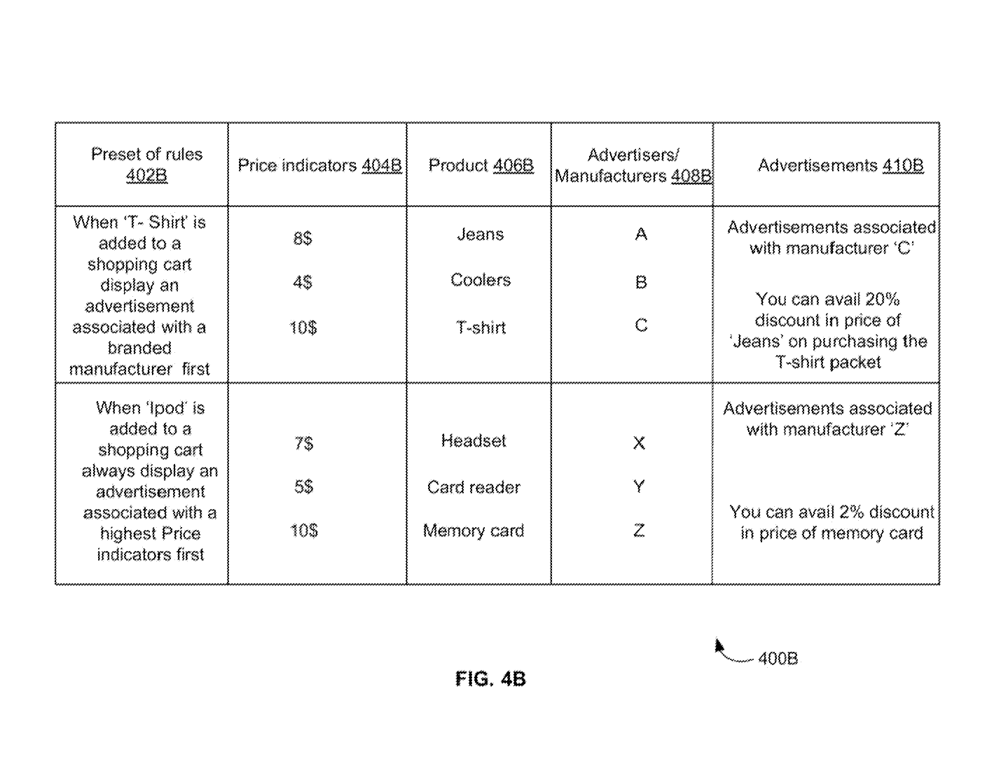

FIG. 4A is a table view 400A illustrating preset rules 402A and price indicators 404A that are defined to display one or more advertisements before adding a product to the shopping cart 110 by the customer 112 of FIG. 1 according to an embodiment herein. The table view 400A further includes a product, field 406A, an advertiser or a manufacturer field 408A, and an advertisements field 410A. For instance, one of the preset rules 402A is “when bread is added to the shopping cart 110 then display an advertisement associated with a branded manufacturer first”. Then, the product identifier processing module 204 processes a product identifier associated with a product (e.g., bread) and identifies the product as bread when the customer 112 adds bread to the shopping cart 110.

Information on (i) manufacturers (e.g., A, B, and C) who are interested in displaying one or more advertisements when a product added to the shopping cart 110 is “Bread” and (ii) corresponding price indicators (e.g., 4$, 12$, and 10$ respectively) to display their advertisements are retrieved from the database 202. In one embodiment, even though the price indicator (e.g., 12$) of manufacturer ‘B’ is more when compared to other two manufacturers (‘A’, and ‘C’) an advertisement (e.g., ‘You can avail 2% discount in price of Jam on purchasing the bread packet’) of manufacturer ‘C’ is displayed or delivered at the shopping cart 110, since the manufacturer ‘C’ has more brand value than the other two manufacturers. In one embodiment, information on brand value is stored in the database 202 of FIG. 2. In one embodiment, the manufacturer of the product ‘bread’ added to the shopping cart 110 is A.

Similarly, for instance, when one of the preset rules 402A is “when an IPod is added to the shopping cart 110 then display an advertisement associated with a highest price indicators first”. Then, the product identifier processing module 204 processes a product identifier associated with a product (e.g., IPod) and identifies the product as ‘IPod’ when the customer 112 adds an IPod to the shopping cart 110, Information on (J) manufacturers (e.g., X, Y, and Z) who are interested in displaying one or more advertisements when a product added to the shopping cart 110 is ‘IPod’ and (ii) corresponding price indicators (e.g., 7$, 5$, and 10$ respectively) to display their advertisements are retrieved from the database 202. In one embodiment, when the price indicator (e.g., 10$) of manufacturer ‘Z’ is more when compared to other two manufacturers (‘X’, and ‘Y’), an advertisement (e.g., ‘You can avail 2% discount in price of Memory card on purchasing the ‘IPod’) of manufacturer ‘Z’ is displayed or delivered at the shopping cart 110.

For instance, when one of the preset rules 402A is “when bread is added to the shopping cart 110, then display an advertisement of jam and its associated highest price indicators”. Then, the product identifier processing module 204 processes a product identifier associated with a product (e.g., bread) and identifies the product as bread when the shopping customer 112 adds bread to the shopping cart 110. Information on manufacturers (e.g., P, Q, and R) who are interested in displaying one or more advertisements when a product added to the shopping cart 110 is “Bread”, and corresponding price indicators (e.g., 4$, 5$, and 10$ respectively) to display their advertisements are retrieved from the database 202. In one embodiment, even though the price indicator (e.g., 10$) of manufacturer ‘R’ is more when compared to the other two manufacturers (‘P’, and ‘Q’) and also the product is jam, an advertisement: (e.g., ‘buy two jam packets and you can avail free one jam packet’) of manufacturer ‘R’ is displayed or delivered at the shopping cart 110.

In one embodiment, when, a product (e.g., bread) of manufacturer ‘A’ is added to the shopping cart 110, an advertisement displayed or delivered at the shopping cart 110 is on bread manufactured by the same manufacturer ‘A’, or alternatively by a different manufacturer (e.g., ‘C’). in another embodiment, when a product (e.g., bread) of manufacturer ‘A’ is added to the shopping cart 110, an advertisement displayed or delivered at the shopping cart 110 is not on ‘bread’. For instance, the advertisement may be on an IPod, milk, cheese, jam, etc. of same manufacturer ‘A’, or of a different manufacturer (e.g., T).

FIG. 4B is a table view 400B illustrating preset rules 402B and price indicators 404B that are defined to display one or more advertisements before adding a product in the online shopping cart 110 by the user 117 of the E-commerce portal 116 of FIG. 1 according to an embodiment herein. The table view 400B further includes a product field 406B, an advertiser or manufacturer field 408B, and an advertisements field 410B. For instance, when one of the preset rules 402B is “when ‘T-shirt’ is added to the online shopping cart 110 then display an advertisement associated with a branded manufacturer first”. And, the product identifier processing module 204 processes a product identifier associated with a product (e.g., T-shirt) and identifies the product as ‘T-shirt’ when the user 117 of the E-commerce portal 116 adds ‘T-shirt’ to the online shopping cart 110. Information on (i) manufacturers (e.g., A, B, and C) who are interested in displaying one or more advertisements when a product added to the online shopping cart 110 is ‘T-shirt’ and (ii) corresponding price indicators (e.g., 8$, 4$, and 10$ respectively) to display their advertisements are retrieved from the database 202. In one embodiment, even though the price indicator (e.g., 10$) of manufacturer ‘B’ is more when compared to other two manufacturers (4% and ‘C’), an advertisement (e.g., ‘You can avail 20% discount in price of ‘Jeans’ on purchasing the T-shirt’) of manufacturer ‘C’ is displayed or delivered at the online shopping cart 110, since the manufacturer ‘C’ is has a brand value than other two manufacturers, in one embodiment, information on brand value is stored in the database 202 of FIG. 2. In one embodiment, the manufacturer of the product ‘T-shirt’ added to the online shopping cart 110 is A.

Similarly, for instance, when one of the preset rules 402B is “when ‘Ipod’ is added to the online shopping cart 110 then display an advertisement associated with a highest price indicators first”. Then, the product, identifier processing module 204 processes a product identifier associated with a product (e.g., IPod) and identifies the product as ‘IPod’ when the user 117 of E-commerce portal 116 adds ‘IPod’ to the online shopping cart 110. Information on (i) manufacturers (e.g., X, Y, and Z) who are interested in displaying one or more advertisements when a product added to the online shopping cart 110 is ‘IPod’ and (ii) corresponding price indicators (e.g., 7$, 5$, and 10$ respectively) to display their advertisements are retrieved from the database 202. In one embodiment, the price indicator (e.g., 10$) of .manufacturer ‘Z’ is more when compared to other two manufacturers (‘X’ and ‘Y’), an advertisement (e.g., ‘You can avail 2% discount in price of Memory card on purchasing the ‘IPod’) of manufacturer ‘Z’ is displayed or delivered at the online shopping cart 110.

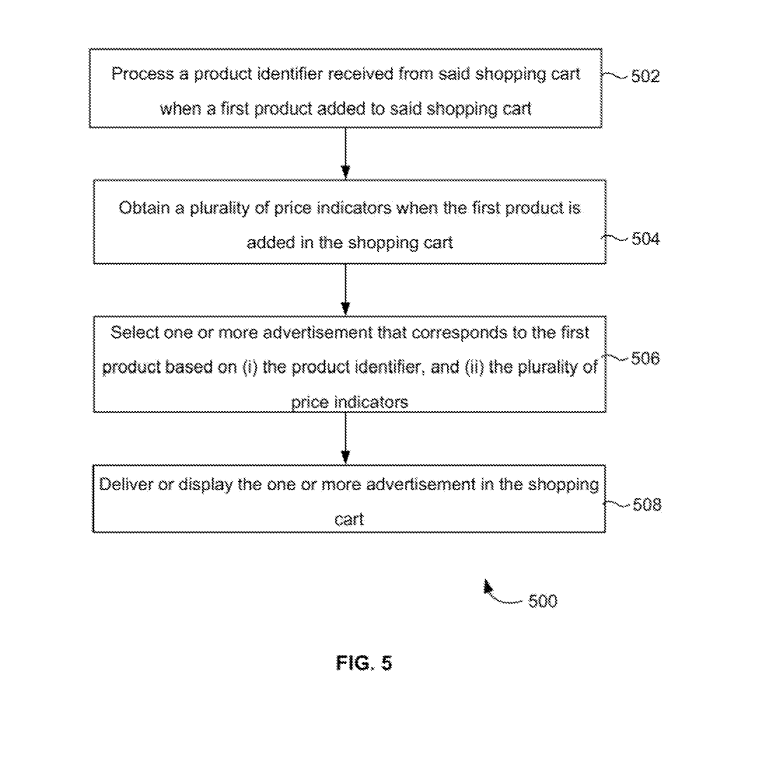

FIG. 5 is a flow diagram illustrating a method of selecting and displaying one or more advertisements when a product is added to the shopping cart 110 according to an embodiment herein. In step 502, a product identifier received from the shopping cart 110 is processed when a first product added to the shopping cart 110. In step 504, a plurality of price indicators is obtained when the first product is added to the shopping cart 110. In step 506, one or more advertisements that correspond to the first product is selected based, on (i) the product identifier, and (ii) the plurality of price indicators. In step 508, the one or more advertisements are delivered or displayed in the shopping cart 110.

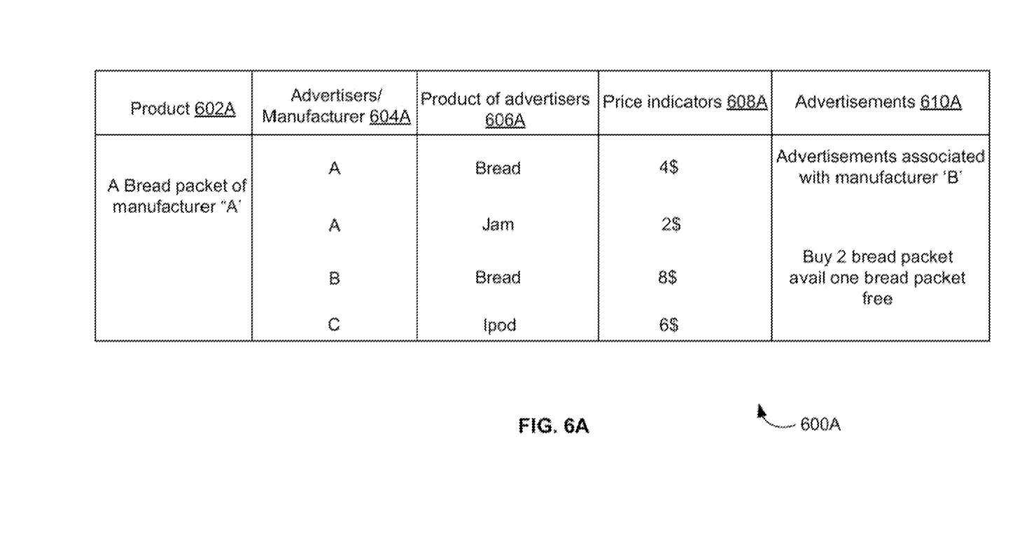

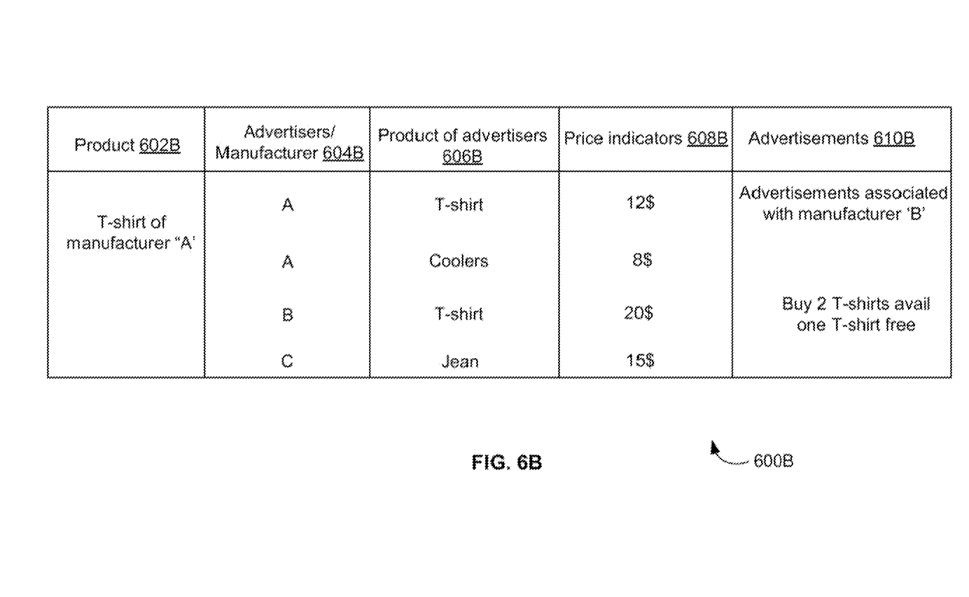

FIG. 6A is a table view 600A illustrating price indicators 608A that are defined to display one or more advertisements when a product is added to the shopping cart 110 by the customer 112 of FIG. 1 according to an embodiment herein. The table view 600A further includes a product field 602A, an advertiser or manufacturer field 604A, a ‘product of advertisers’ field 606A, and an advertisements field 610A. For instance, when a bread packet of a manufacturer ‘A’ is added to the shopping cart 110, the product identifier processing module 204 processes a product identifier associated with a product (e.g., bread) and identifies the product as bread. Information on manufacturers (e.g., A, B, and C) who are interested in displaying one or more advertisements when a product added to the shopping cart 110 is “Bread”, and their corresponding price indicators (e.g., 4$ for ‘Bread’ and 2$ for ‘Jam’, 8$, and 6$ respectively) for displaying their advertisements are retrieved from the database 202. In one embodiment, when the price indicator (e.g., 8$) of manufacturer ‘B’ is more when compared to other two manufacturers (‘A’, and ‘C’), an advertisement (e.g., ‘Buy two Jam packet and you can avail free one Jam packet’) of manufacturer ‘B’ is displayed or delivered at the shopping cart 110.

FIG. 6B is a table view 600B illustrating price indicators 608B that are defined to display one or more advertisements when a product is added to the online shopping cart 110 by the user 111 of the E-commerce portal 116 of FIG. 1 according to an embodiment herein. The table view 6006 further includes a product field 602B, an advertiser or manufacturer field 604B, a ‘product of advertisers’ field 606B, and an advertisements field 610B. For instance, when a T-shirt of manufacturer ‘A’ is added to the online shopping cart 110, the product identifier processing module 204 processes a product identifier associated with a product (e.g., T-shirt) and identities the product as a T-shirt. Information on (i) manufacturers (e.g., A, B, and C) who are interested in displaying one or more advertisements when a product added to the online shopping cart 110 is “T-shirt”, and (ii) corresponding price indicators (e.g., 12$ for ‘T-shirt’ and 8$ for ‘Coolers’, 20$, and 15$ respectively) to display their advertisements are retrieved front the database 202. In one embodiment, when the price indicator (e.g., 20$) of manufacturer ‘B’ is more when compared to other two manufacturers (‘A’ and ‘C’), an advertisement (e.g., ‘Buy two T-shirts avail one T-shirt free’) of manufacturer ‘B’ is displayed or delivered at the online shopping cart 110.

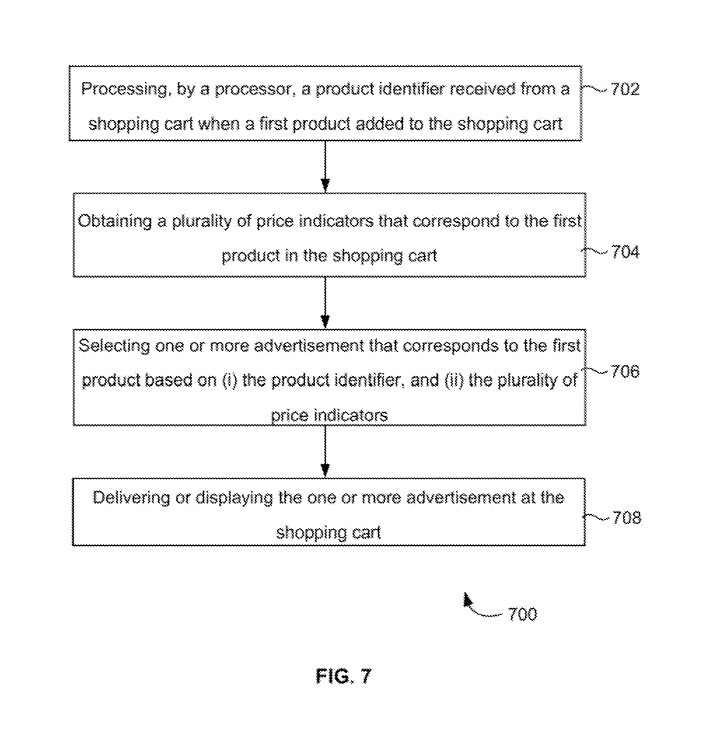

FIG. 7 is a flow diagram illustrating a method of selecting and displaying a targeted advertisement at the shopping cart 110 according to an embodiment herein. In step 702, a product identifier received from a shopping cart is processed by a processor when a first product added to the shopping cart. In step 704, a plurality of price indicators that correspond, to the first product in the shopping cart is obtained. In step 706, one or more advertisements that correspond to the first product is selected based on (i) the product identifier, and (ii) the plurality of price indicators. In step 708, the one or more advertisements at the shopping cart is delivered or displayed.

In the above embodiments, one or more targeted advertisements are selected and delivered to the shopping cart 110 based on a product added to the shopping cart 110 and are identified by the product identifier processing module 204 of FIG. 2. However, the user devices (e.g., a tablet) of one or more customers may also be used to identify one or more products in one or more shopping carts, and accordingly select and deliver one or more advertisements. In one embodiment, the user device 122 includes the advertisement selection and delivery tool 118.

The customer 112 slides the user device 122 to the shopping cart 110. The product identifier and processing module 204 of the user device 122 processes one or more product identifiers received front one or more shopping carts when one or more products am added to the one or mom shopping cam. Also, the product identifier and processing module 204 identifies the one or mom products based on the one or more product identifiers. For example, a first user adds products (e.g., bread, soap, and a milk boiler) to a first shopping cart with a first user device, and a second user adds products (e.g., soap, a dozen of egg, and oil) to a second shopping cart, with a second, user device.

The first user device processes a product identifier of a corresponding product in the first shopping cart, and identifies the products (e.g., bread, soap, and the milk boiler) in the first shopping cart. Similarly, the second user device processes a product identifier of corresponding product in the second shopping cart, and identifies the products (e.g., soap, the dozen of egg, and oil) in the second shopping cart. Once, the one or more products in the shopping carts are identified, one or more price indicators from one or more advertisers are obtained to display/deliver their advertisements.

In one embodiment, based on the products in the first shopping cart and the second shopping cart, one or more price indicators are received from the one or more advertisers. For example, both the first shopping cart and the second shopping cart include a common product ‘soap’. Thus, advertisements on “soap” and on related products (e.g., shampoo, deodorant, etc.) are more likely targeted to both first user and the second user. One or more price indicators (e.g., a shampoo manufacturer/advertiser ‘A’ indicates 2$ to display their advertisement, and a deodorant manufacturer/advertiser ‘B’ indicates 3$ to display their advertisement) are obtained. Once the one or more price indicators are obtained, one or more advertisements are selected based on (i) the one or more product identifiers, and (ii) the one or more price indicators. For instance, the advertisement associated with the manufacturer/advertiser ‘B’ is selected since they are highest price indicators. Thus, the advertisement associated with the manufacturer/advertiser ‘B’ is displayed/delivered at the first shopping cart, and the second shopping cart,

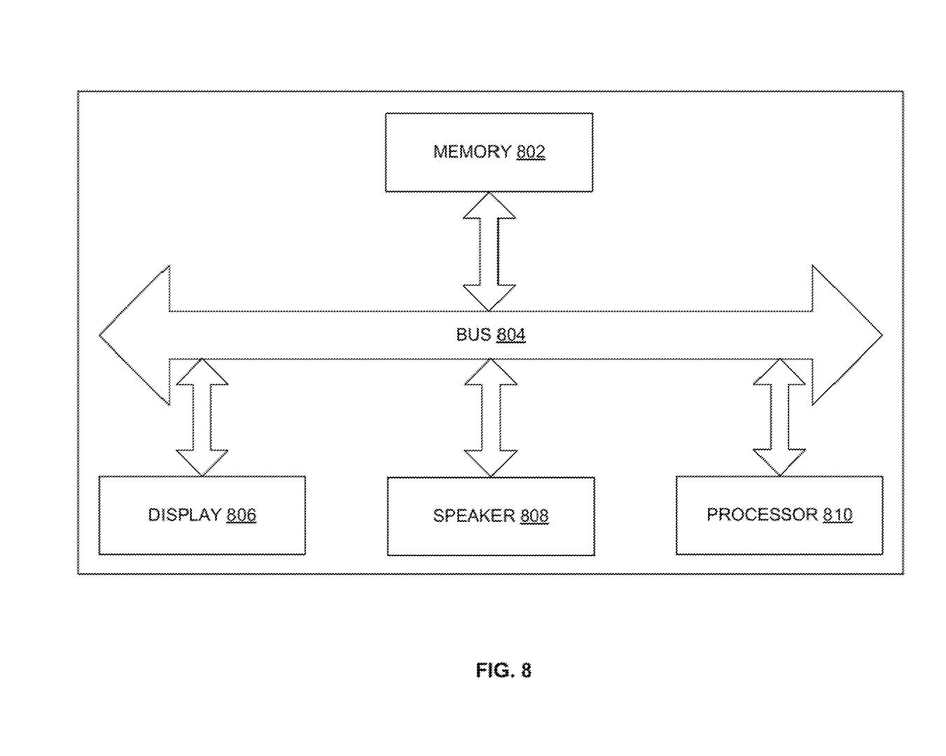

FIG. 8 illustrates an exploded view of the transceiver 108 of FIG. 1 having an a memory 802 having a set of computer instructions, a bus 804, a display 806, a speaker 808, and a processor 810 capable of processing a set of instructions to perform any one or more of the methodologies herein, according to an embodiment herein. In one embodiment, the receiver may be the transceiver 108. The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the defected information bits) available in the future or stored from the past. A user of the receiver may view this stored information on display 806 and select an item of for viewing, listening, or other uses via input, which may take the form of keypad, scroll or other input device(s) or combinations thereof. When digital, content is selected, the processor 810 may pass information. The content and PSI/SI may be passed among functions within the transceiver 108 using the bus 804.

The techniques provided by the embodiments herein may be implemented on an integrated circuit chip (not shown). The chip design is created in a graphical computer programming language, and stored hi a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entitles, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic earlier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor,

The embodiments herein can rake the form of, as entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, stem, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system, either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

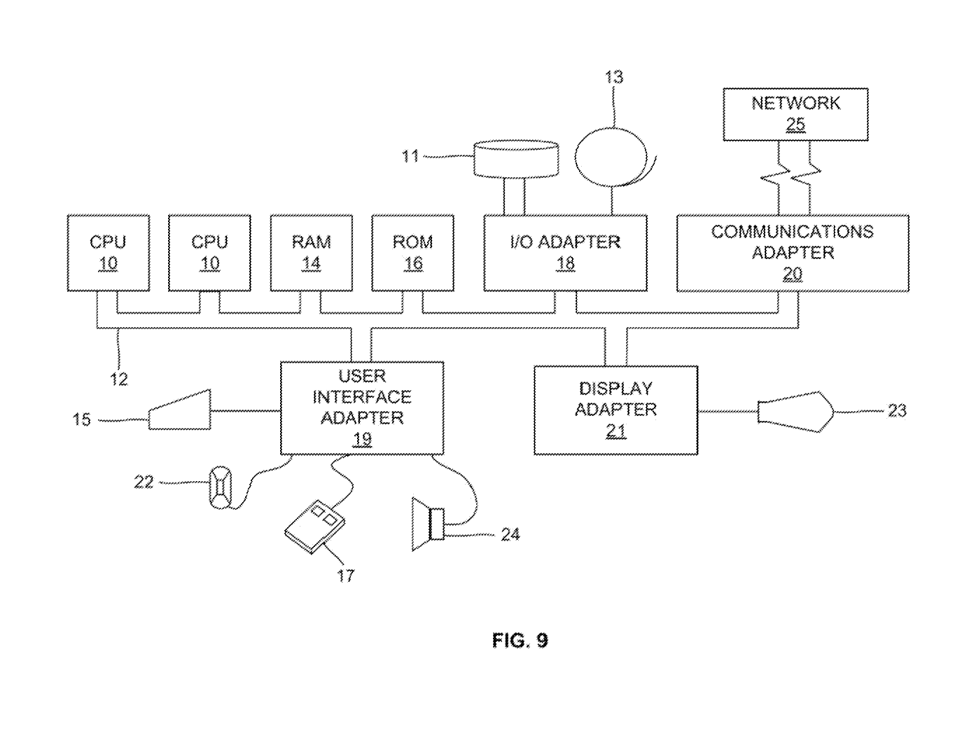

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system, can read the inventive instructions on the program storage devices and follow these instructions to execute the methodology of the embodiments herein.

The system further includes a user interlace adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The advertisement selection and delivery tool 118 may provide the customer 112a better satisfaction of getting relevant, good products at a lower cost, with good shopping experience. Also, the customer 112 may be made aware of the right offer at the right time for a specific product added to the shopping cart 110. The advertisement selection and delivery tool 118 may provide retail market owners with increased sales, and provide value added services for customers. Also, the retail market owners are offered significant cost savings in pushing advertisement and offers to the customers.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A method of selecting and displaying of a targeted advertisement at a shopping cart, said method comprising;
(a) processing, by a processor, a product identifier received from said shopping cart when a first product added to said shopping cart, wherein said product identifier is unique and specific to said first product;
(b) obtaining a plurality of price indicators that correspond to said first product in said shopping cart;
(c) selecting at least one advertisement that corresponds to said first product based on (i) said product identifier, and (ii) said plurality of price indicators; and
(d) delivering or displaying said at least one advertisement at said shopping cart

2. The method of claim 1, wherein said at least one advertisement is further selected based on (i) a preset of rules that are defined before adding said first product in said shopping cart, and wherein said plurality of price indicators are stored in a database.

3. The method of claim 1, wherein said plurality of price indicators are obtained when said first product is added to said shopping cart

4. The method of claim 1, wherein said at least one advertisement comprises at least one of (i) an offer, and (ii) a discount on purchasing said first product.

5. The method of claim 1, wherein said at least one advertisement comprises a promotion on a second product on purchasing said first product, wherein said second product is different from said first product.

6. The method of claim 1, wherein said product identifier comprises at least one of (i) a code, (ii) a batch number, and (iii) a name of a manufacturer associated with said first product.

7. The method of claim 1, wherein said at least one advertisement is delivered to said shopping cart comprises at least one of (i) an audio message, (ii) a visual message, and (iii) a printable message.

8. The method of claim 1, wherein said plurality of price indicators is obtained based on a previous transaction associated with previous purchase of said first product,

9. An intent channel server for selection and displaying of a targeted advertisement at a shopping cart said intent channel server comprising:
a memory unit that stores (i) a set of modules, and (ii) a database comprising (a) a plurality of price indicators, (b) a plurality of advertisements, and (c) a plurality of product identifiers, and (d) a preset of rules that am defined before adding a product in said shopping cart;
a display unit; and
a processor that executes said set of modules, wherein said set of modules comprises:
(a) a product identifier processing module executed by said processor that processes a product identifier received from said shopping cart when a first product added to said shopping cart, wherein said product identifier is unique and specific to said shopping cart;
(b) an advertisement selection module executed by said processor that selects at least one advertisement that corresponds to said first product iron said plurality of advertisements based on (i) said product identifier, (ii) said plurality of price indicators, and (iii) said preset of rules that are stored in said database before adding said first product in said shopping cart; and
(c) an advertisement delivering module executed fey said processor that delivers said at least one advertisement to said shopping cart.

10. The intent channel server of claim 9, wherein said at least one advertisement comprises at least one of (i) an offer, and (ii) a discount on purchasing said first product.

11. The intent channel server of claim 9, wherein said at least one advertisement comprises a promotion on a second product on purchasing said first product, wherein said second product is different from, said first product.

12. A system for selection and displaying of a targeted advertisement at a shopping cart comprising:
a transceiver associated with said shopping cart, wherein said, transceiver
comprises (i) a processor that is configured to;
(a) identify a product identifier which is unique and specific to a first product when said first product added to said, shopping cart;
(b) obtain a plurality of price indicators when said first product is added in said shopping cart, wherein said plurality of price indicators correspond to said first product;
(c) select at least one advertisement that corresponds to said first product based on (i) said product identifier, and (ii) said plurality of price indicators; and
(d) display said at least one advertisement in said shopping cart.

13. The system of claim 12, wherein said at least one advertisement comprises at least one of (i) an offer, and (ii) a discount on purchasing said first product.

14. The system of claim 12, wherein said at least one advertisement comprises a promotion on a second product on purchasing said first product, wherein said second product Is different from said first product.

15. The system of claim. 14, wherein, said processor that is further configured to (e) obtain said plurality of price indicators based on a previous transaction associated with previous purchase of said first product.

16. An intent channel server for selection and displaying of a targeted advertisement at a shopping cart, said intent channel server comprising:
a memory unit that stores (i) a set of modules, and (ii) a database;
a display unit; and
a processor that executes said, set of modules, wherein said set of modules comprises:
(a) a product identifier processing module executed by said processor that processes a product identifier received from said shopping cart when a first product added to said shopping cart, wherein said product identifier is unique and specific to said first product;
(b) a price indicator obtaining module executed by said processor that obtain a plurality of price indicators when said first product is added in said shopping cart, wherein said plurality of price indicators correspond to said first product;
(c) an advertisement selection module executed by said processor that selects at least one advertisement that corresponds to said first product based on (i) said product identifier, and (ii) said plurality of price indicators; and
(c) an advertisement delivering module executed by said processor that delivers said at least one advertisement to said shopping cart,

17. A system for selection and displaying of a targeted advertisement at a shopping cart comprising:
a transceiver associated with said shopping cart, wherein said transceiver
comprises (i) a processor that is configured to;
(a) process a product identifier when a first product added to said shopping cart, wherein said product identifier is unique and specific to said shopping cart;
(b) select at least one advertisement that corresponds to said first product based on (i) said product identifier, and (ii) a plurality of price indicators, and (iii) a preset of rules, wherein said preset of rules and said plurality of price indicators are defined before adding said first product in said shopping cart; and
(c) display said at feast one advertisement in said shopping cart,

18. A method of selecting and displaying of a targeted advertisement at a plurality of shopping carts, said method comprising:
(a) processing, by a processor, a plurality of product identifiers received from said, plurality of shopping carts when a plurality of products are added to said plurality of shopping carts, wherein each of said plurality of product identifiers is unique and specific to a product of said plurality of products;
(b) identifying said plurality of products based on said plurality of product identifiers;
(c) obtaining a plurality of price indicators based on said plurality of products in said plurality of shopping carts;
(d) selecting at least one advertisement that corresponds to at least one product of said plurality of products based on (i) said plurality of product identifiers, and (ii) said plurality of price indicators; and
(e) delivering or displaying said at least one advertisement at said plurality of stopping carts.
